(19) United States
(12) Patent Application Publication
(10) Pub. No.: US 2013/0251238 A1
(43) Pub. Date: Sep. 26, 2013

(54) METHODS OF ALIGNING OBJECTS AND APPARATUSES FOR PERFORMING THE SAME

(71) Applicant: SAMSUNG ELECTRONICS CO., LTD., Suwon-Si (KR)

(72) Inventors: Hak-Seung HAN, Hwaseong-si (KR); Jin-Back PARK, Suwon-si (KR); In-Kyun SHIN, Yongin-si (KR)

(73) Assignee: SAMSUNG ELECTRONICS CO., LTD., Suwon-Si (KR)

(21) Appl. No.: 13/671,685

(22) Filed: Nov. 8, 2012

(30) Foreign Application Priority Data
Mar. 26, 2012 (KR) 10-2012-0030330

(51) Int. Cl. G06T 7/00

(52) U.S. Cl. CPC G06T 7/001
USPC 382/151

(57) ABSTRACT

A method of aligning an object may include obtaining a first actual image of a first pattern on the object, setting the first actual image as a first reference image, obtaining a second actual image of a second pattern on the object, comparing the second actual image with the first reference image to obtain first relative position difference values of the second actual image with respect to the first reference image, and converting the first relative position difference values into first absolute position difference values with respect to a reference point on the object.

### CROSS-RELATED APPLICATION(S)

This application claims priority from Korean Patent Application No. 10-2012-0030330, filed on Mar. 26, 2012, in the Korean Intellectual Property Office (KIPO), the entire contents of which are incorporated herein by reference.

### BACKGROUND

1. Field

Some example embodiments may relate to methods of aligning objects and/or apparatuses for performing the same. Some example embodiments may relate to methods of measuring registration of mask patterns in masks and/or apparatuses for performing the methods.

2. Description of Related Art

Generally, a mask may be used for forming a desired pattern on a semiconductor substrate. The mask may have a mask pattern having a shape corresponding to that of the desired pattern. The mask may be arranged over a photoresist film and a layer on the semiconductor substrate. A light may be irradiated to the photoresist film through the mask. The photoresist film may be developed to form a photoresist pattern. The layer may be etched using the photoresist pattern as an etch mask to form the desired pattern on the semiconductor substrate.

Therefore, in order to provide the pattern with a desired shape, it may be required to accurately locate the mask pattern at a designed position as well as to provide the mask pattern with a designed shape.

Here, a position accuracy of the mask pattern may be represented as a registration. The registration may be a difference value between a real position coordinate of the mask pattern and a designed position coordinate of the mask pattern in the mask. Before performing an exposing process, a pattern having a desired shape and a desired position may be formed by correcting the real position of the mask pattern based on a measured registration.

According to related method of measuring a registration, a separated registration key may be formed on a mask. A position of the registration key may be measured. The measured position of the registration key may be compared with a predetermined reference position to obtain the registration.

However, as semiconductor devices may have been highly integrated, a size of a pattern may be reduced. As a result, a size of a mask pattern may also become smaller. Therefore, it may be difficult to secure a space of the mask where the separated registration key may be formed. Particularly, when a desired pattern may include minutely arranged cell array patterns, forming the registration key in a narrow space between the cell array patterns may be very difficult.

Further, in the method of measuring the registration, the registration may be measured from a position of the registration key, so that the measured registration may not accurately represent an actual registration of a real mask pattern. Thus, when a position of a mask pattern may be corrected based on the registration obtained from the registration key, the corrected position of the mask pattern may not be positioned at a designed position. As a result, a pattern formed using the mask including the corrected mask pattern may not have a desired shape and a desired position.

### SUMMARY

Some example embodiments may provide methods of accurately aligning objects without separated registration keys.

Some example embodiments may provide apparatuses for performing the above-mentioned methods.

In some example embodiments, a method of aligning an object may comprise obtaining a first actual image of a first pattern on the object; setting the first actual image as a first reference image; obtaining a second actual image of a second pattern on the object; comparing the second actual image with the first reference image to obtain first relative position difference values of the second actual image with respect to the first reference image; and/or converting the first relative position difference values into first absolute position difference values with respect to a reference point on the object.

In some example embodiments, the comparing the second actual image with the first reference image may comprise overlapping the second actual image with the first reference image.

In some example embodiments, the comparing the second actual image with the first reference image may further comprise obtaining contrast waveforms of the first reference image and the second actual image.

In some example embodiments, the obtaining contrast waveforms may comprise setting an allowable range on the contrast waveforms; and/or removing portions of the contrast waveforms beyond the allowable range from the contrast waveforms.

In some example embodiments, the comparing the second actual image with the first reference image may further comprise shifting the second actual image on the first reference image to a position at which the first relative position difference values are minimized.

In some example embodiments, the comparing the second actual image with the first reference image may further comprise correcting the second actual image to provide the second actual image with a size substantially the same as that of the first reference image.

In some example embodiments, the method may further comprise obtaining a third actual image of a third pattern on the object; setting the third actual image as a second reference image; obtaining a fourth actual image of a fourth pattern on the object; comparing the fourth actual image with the second reference image to obtain second relative position difference values of the fourth actual image with respect to the second reference image; and/or converting the second relative position difference values into second absolute position difference values with respect to the reference point on the object.

In some example embodiments, the method may further comprise calculating an average value of the first absolute position difference values and the second absolute position difference values.

In some example embodiments, the reference point may comprise a center point of the object.

In some example embodiments, the object may comprise a mask. The patterns may comprise mask patterns on the mask. The first absolute position difference values may comprise a registration of the mask.

In some example embodiments, an apparatus for aligning an object may comprise an image-obtaining unit configured to obtain actual images of patterns on the object; an image-comparing unit configured to set at least one of the actual images as a reference image, and configured to compare the actual images with the reference image to obtain relative position difference values of the actual images with respect to the reference image; and/or a calculating unit configured to convert the relative position difference values into absolute position difference values with respect to a reference point on the object.

In some example embodiments, the image-comparing unit may comprise an image-overlapping member configured to overlap the actual images with the reference image; and/or a shifting member configured to shift the actual images on the reference image to positions at which the relative position difference values are minimized.

In some example embodiments, the image-overlapping member may comprise a contrast obtainer configured to obtain contrast waveforms of the reference image and the actual images; and/or a filter configured to remove portions of the contrast waveforms beyond an allowable range from the contrast waveforms.

In some example embodiments, the image-comparing unit may further comprise an image-correcting member configured to correct the actual images to provide the actual images with a size substantially the same as that of the reference image.

In some example embodiments, the object may comprise a mask. The patterns may comprise mask patterns on the mask. The absolute position difference values may comprise a registration of the mask.

In some example embodiments, a method of aligning an object may comprise setting an actual image of a first pattern on the object as a first reference image; determining first relative position difference values based on an actual image of a second pattern on the object and the first reference image; and/or converting the first relative position difference values into first absolute position difference values with respect to a reference point on the object.

In some example embodiments, the object may comprise a mask.

In some example embodiments, the patterns may comprise mask patterns on a mask.

In some example embodiments, the absolute position difference values may comprise a registration of a mask.

In some example embodiments, the reference point may comprise a center point of the object.

In some example embodiments, the method may further comprise setting an actual image of a third pattern on the object as a second reference image; comparing an actual image of a fourth pattern on the object with the second reference image to obtain second relative position difference values; and/or converting the second relative position difference values into second absolute position difference values with respect to the reference point on the object.

In some example embodiments, the method may further comprise calculating an average value of the first and second absolute position difference values.

In some example embodiments, the object may comprise a mask.

In some example embodiments, the patterns may comprise mask patterns on a mask.

In some example embodiments, the absolute position difference values may comprise a registration of a mask.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a block diagram illustrating an apparatus for measuring a registration of a mask in accordance with some example embodiments;

FIG. 2 is a flow chart illustrating a method of measuring a registration of a mask using the apparatus in FIG. 1;

FIG. 3 is a flow chart illustrating an overlapping process in the method in FIG. 2;

FIG. 4 is a perspective view illustrating a mask having mask patterns.

FIG. 5 is a picture illustrating a first actual image of a first mask pattern formed at a first region on the mask pattern in FIG. 4;

FIG. 6 is a picture illustrating a second actual image of a second mask pattern formed at a second region on the mask pattern in FIG. 4;

FIG. 7 is a contrast waveform of an actual image;

FIGS. 8 to 10 are pictures illustrating processes for overlapping the second actual image in FIG. 6 with the first actual image in FIGS. 5; and

FIGS. 11A and 11B are flow charts illustrating a method of measuring a registration of a mask using the apparatus in FIG. 1 in accordance with some example embodiments.

### DETAILED DESCRIPTION OF THE EMBODIMENTS

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature, their shapes are not intended to illustrate the actual shape of a region of a device, and their shapes are not intended to limit the scope of the example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

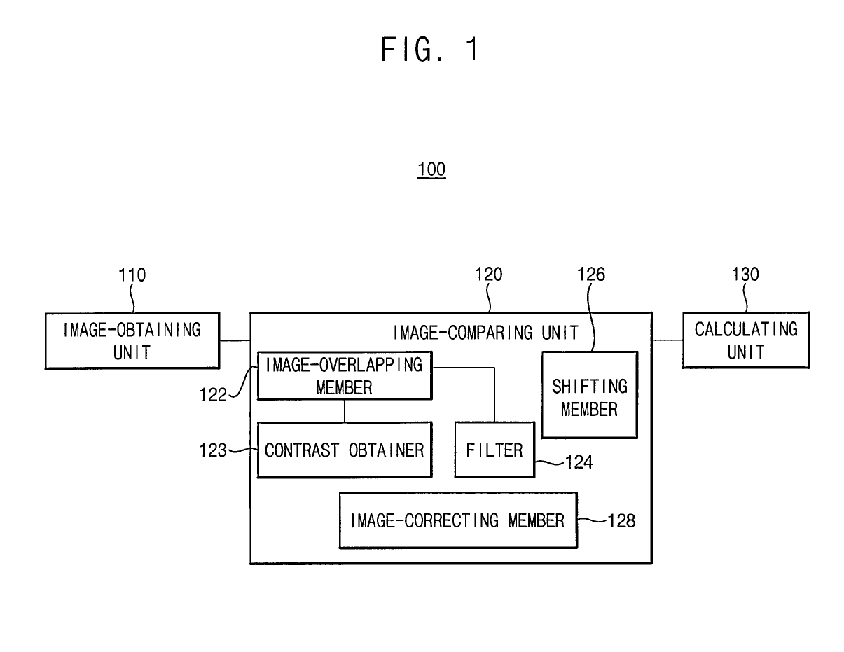

FIG. 1 is a block diagram illustrating an apparatus for measuring a registration of a mask in accordance with some example embodiments.

Referring to FIG. 1, an apparatus 100 for measuring a registration of a mask in accordance with some example embodiments may include an image-obtaining unit 110, an image-comparing unit 120, and a calculating unit 130.

In some example embodiments, as shown in FIG. 4, the mask M may have a mask pattern P. The mask M may be divided into a plurality of regions. The mask patterns P may be arranged in each of the regions on the mask M. Each of the mask patterns P may have substantially the same shape.

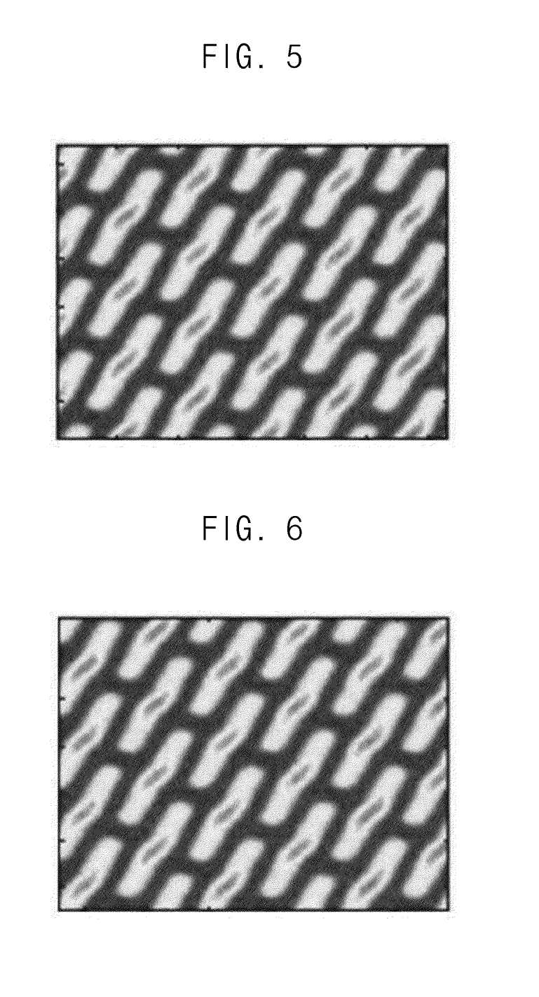

The image-obtaining unit 110 may obtain actual images of the mask patterns P on the mask M. In some example embodiments, the image-obtaining unit 110 may obtain a first actual image of a first mask pattern (See FIG. 5) arranged in a first region, and a second actual image of a second mask pattern (See FIG. 6) arranged in a second region among the mask patterns P on the mask M. The image-obtaining unit 110 may include a charge coupled device (CCD) camera.

In some example embodiments, the image-obtaining unit 110 may obtain the actual images of at least two mask patterns P. A measured registration may be more accurate in proportion to the number of the actual images obtained by the image-obtaining unit 110.

The image-comparing unit 120 may set any one among the actual images obtained by the image-obtaining unit 110 as a reference image. In some example embodiments, the first actual image of the first mask pattern in the first region may be set as the reference image.

The image-comparing unit 120 may sequentially compare the rest of the actual images with the reference image to obtain relative position difference values that may mean deviated amounts of the actual images from the reference image. That is, the relative position difference images may mean distances from coordinates of points on the reference image to coordinates of corresponding points on each of the actual images.

In some example embodiments, the image-comparing unit 120 may include an image-overlapping member 122, a shifting member 126 and an image-correcting member 128.

The image-overlapping member 122 may sequentially overlap the actual images on the reference image. In some example embodiments, when the actual images may be compared with the reference image by overlapping the actual images on the reference image, the reference image and the actual images may include noise. The noise may accurately represent the actual mask pattern P to cause measurement errors of the registration. Thus, the image-overlapping member 122 may include a contrast obtainer 123 and a filter 124 for removing the noise.

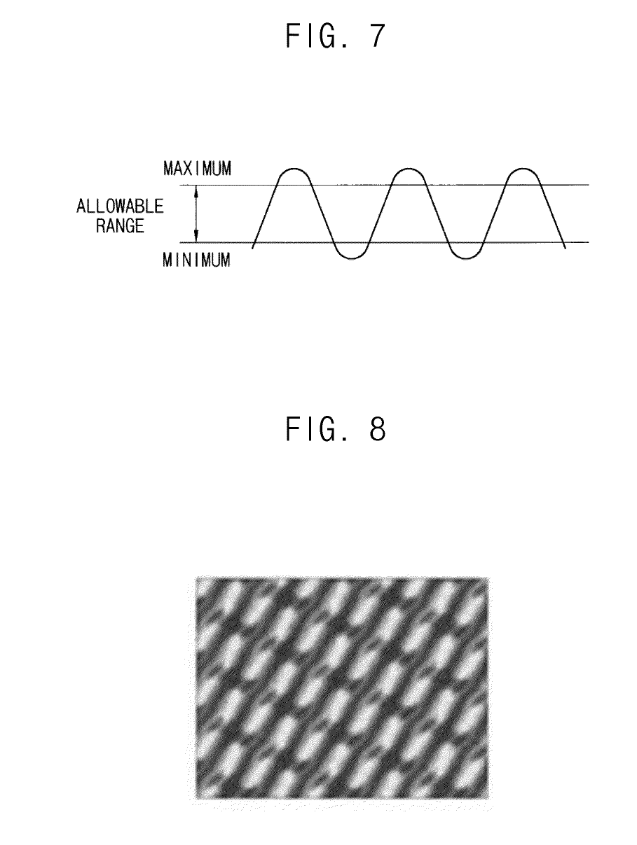

The contrast obtainer 123 may obtain a contrast waveform of the actual image (See FIG. 7). The filter 124 may filter portions of the contrast waveform beyond an allowable range from the contrast waveform. For example, filter 124 may remove a portion of the contrast waveform above a maximum contrast. Alternatively, the filter 124 may remove a portion of the contrast waveform below a minimum contrast.

When the actual images may be compared with the reference image, a reference point of the actual image may be shifted left from a reference point of the reference image. Although a registration between the actual images may be very small, the reference point shift may result in a very large relative position difference value. That is, the reference shift on the actual image may not be directly related to the registration of the mask M. Therefore, the image-comparing unit 120 may further include a shifting member 126 for aligning the reference points of the reference image and the actual image with each other.

In some example embodiments, as shown in FIGS. 8 to 10, the shifting member 126 may shift the actual image on the reference image to align the reference points of the reference image and the actual image with each other. That is, the shifting member 126 may accurately overlap the mask pattern of the actual image with the mask pattern of the reference image to provide the mask patterns P with a uniform pitch, thereby minimizing the relative position difference values.

In some example embodiments, the image-obtaining unit 110 may obtain the actual images of arbitrary regions on the mask M regardless of an area, a shape, an arrangement, etc., of a mask pattern in a specific region on the mask M. Thus, the actual images may have different areas. When the shifting member 126 may shift the actual image on the reference image, it may be required to overlap the actual image having an area, which may be substantially the same as that of the reference image, with the reference image with respect to the reference point.

The image-correcting member 128 may correct a size of the actual image to provide the actual image with a size substantially the same as that of the reference image. Thus, the image-correcting member 128 may expand or reduce the size of the actual image in accordance with the size of the reference image.

In some example embodiments, the minimized relative position difference values may be measured values with respect to the reference image. For example, relative position difference values obtained by comparing the second actual image with the reference image may be values representing relative positions of the second actual image with respect to the reference image. Therefore, the relative difference values of the second actual image may not represent registrations of other mask patterns. Thus, it may be required to convert the relative position difference values into an absolute position difference value with respect to a reference point set on the mask M that may be applicable to the mask patterns P on the entire regions of the mask M.

The calculating unit 130 may convert the minimized relative position difference values into the absolute position difference value. The absolute position difference value may be values representing absolute positions of the actual images with respect to the reference point set on the mask M, not the reference image. The absolute position difference value may correspond to the registration of the mask M. In some example embodiments, the reference point on the mask M may correspond to a center point of the mask M.

Further, when the actual images may be compared with the reference image, the absolute position difference value may be in plural by points of each of the actual images. Thus, the calculating unit 130 may calculate an average value of the absolute position difference values by each of points. The average value may correspond to an accurate registration of the actual images with respect to the reference point on the mask M.

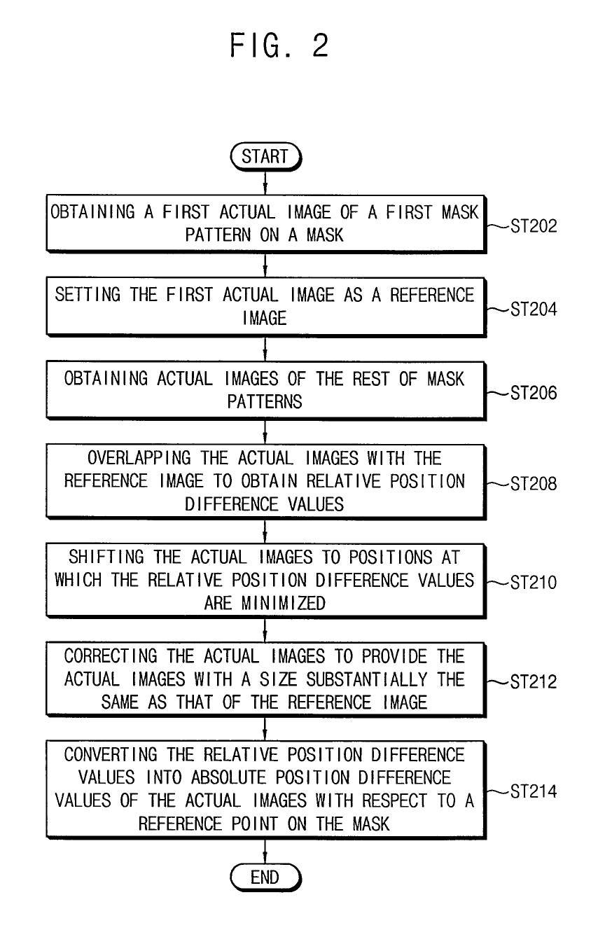

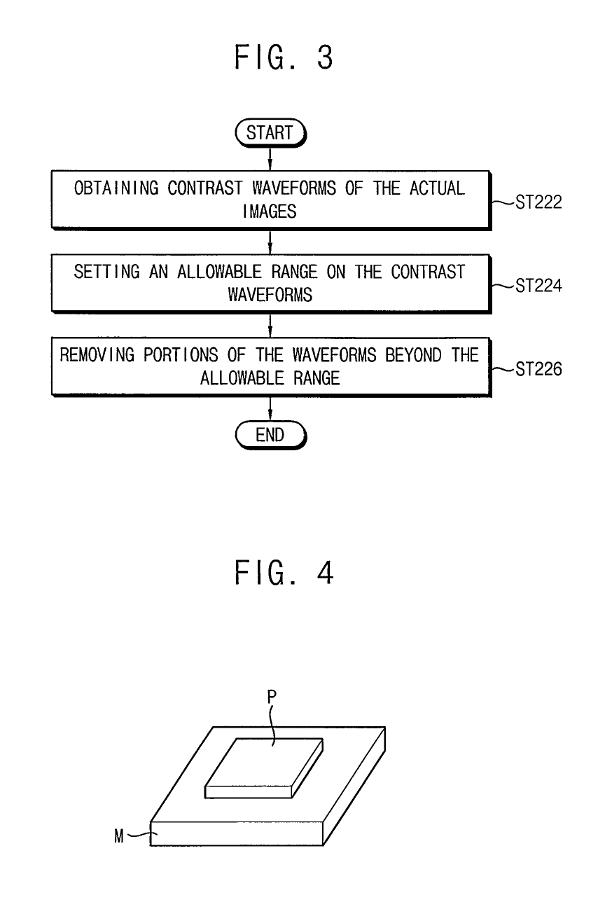

FIG. 2 is a flow chart illustrating a method of measuring a registration of a mask using the apparatus in FIG. 1, and FIG. 3 is a flow chart illustrating an overlapping process in the method in FIG. 2.

Referring to FIGS. 1 to 3, in step ST202, the image-obtaining unit 110 may photograph the first mask pattern in the first region of the mask M to obtain the first actual image in FIG. 5.

In step ST204, the image-comparing unit 120 may set the first actual image as the reference image.

In step ST206, the image-obtaining unit 110 may photograph the mask patterns in other regions of the mask M to obtain the actual images. In some example embodiments, the image-obtaining unit 110 may photograph the second mask pattern in the second region of the mask M to obtain the second actual image in FIG. 6.

In step ST208, the image-overlapping member 122 of the image-comparing unit 120 may overlap the second actual image with the reference image to obtain relative position difference values of the second actual image with respect to the reference image.

In some example embodiments, the overlapping process may include processes shown in FIG. 3. In step ST222, the contrast obtainer 123 may obtain contrast waveforms of the reference image and the actual images. In step ST224, in order to remove noise in the reference image and the actual images, the contrast obtainer 123 may set an allowable range between a maximum contrast and a minimum contrast. In step ST226, the filter 124 may remove portions of the contrast waveforms beyond the allowable range. That is, the filter 124 may remove a portion of the contrast waveform above the maximum contrast and a portion of the contrast waveform below the minimum contrast to remove the noise from the reference image and the actual images.

The second mask pattern may be shifted left. Thus, when the image-overlapping member 122 may overlap the second actual image with the reference image, an area difference between the reference image and the second actual image may be very large.

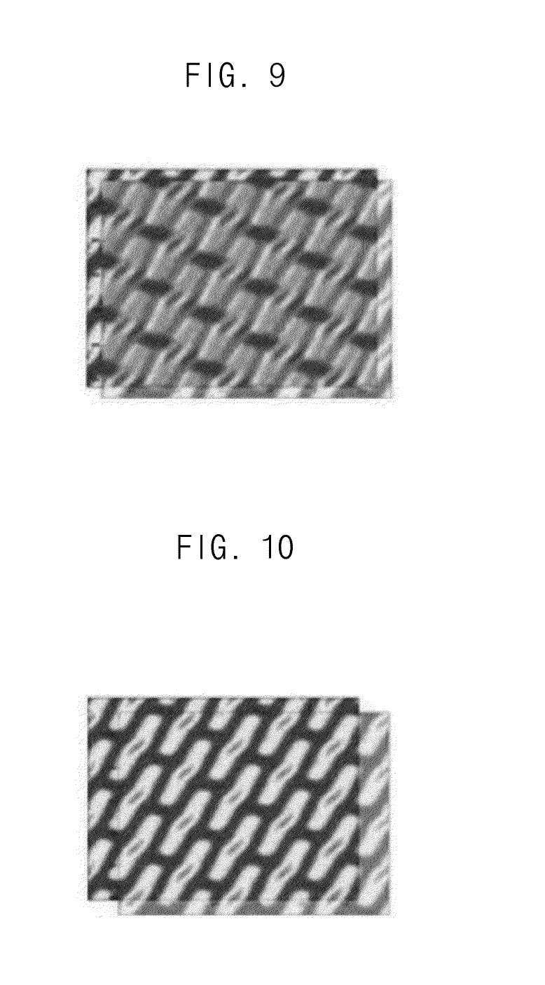

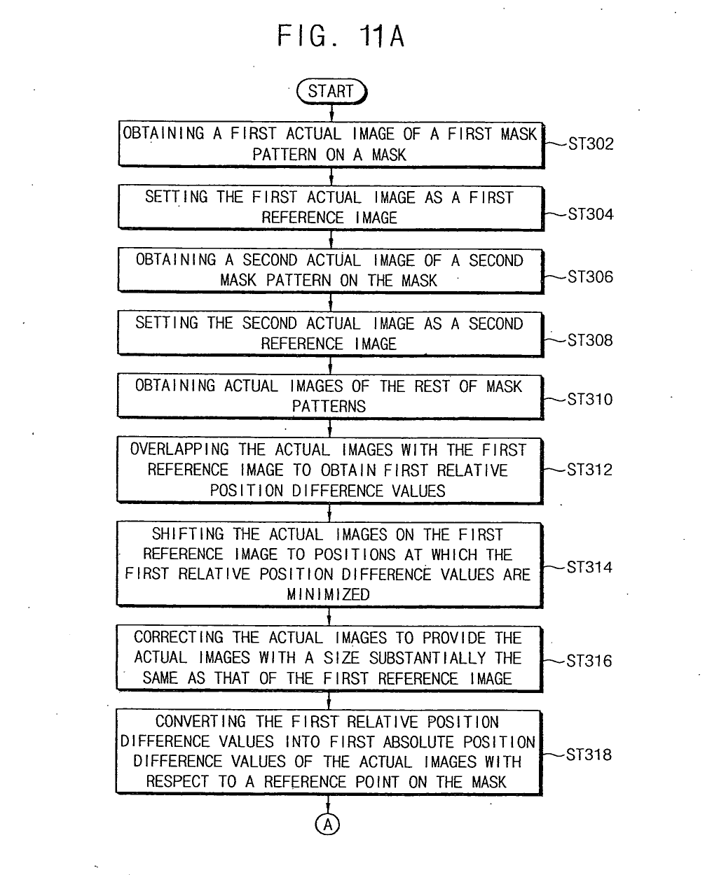

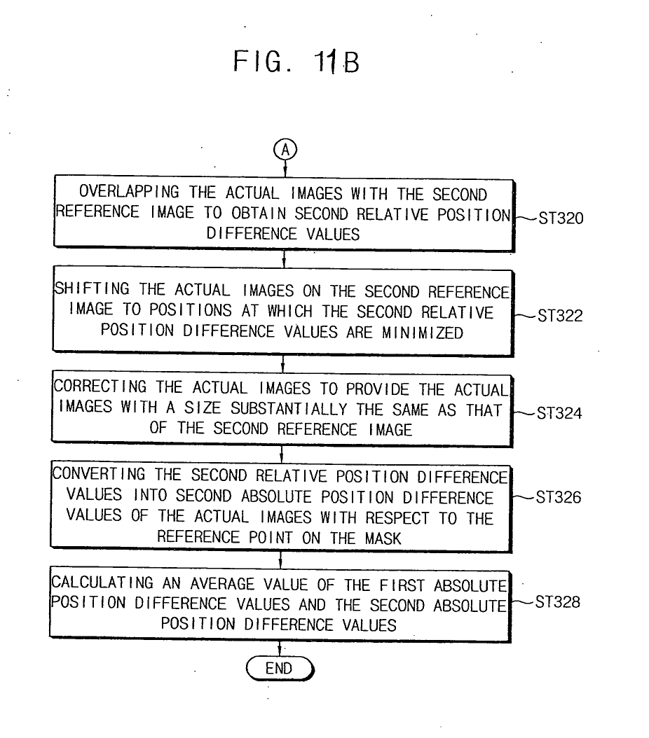

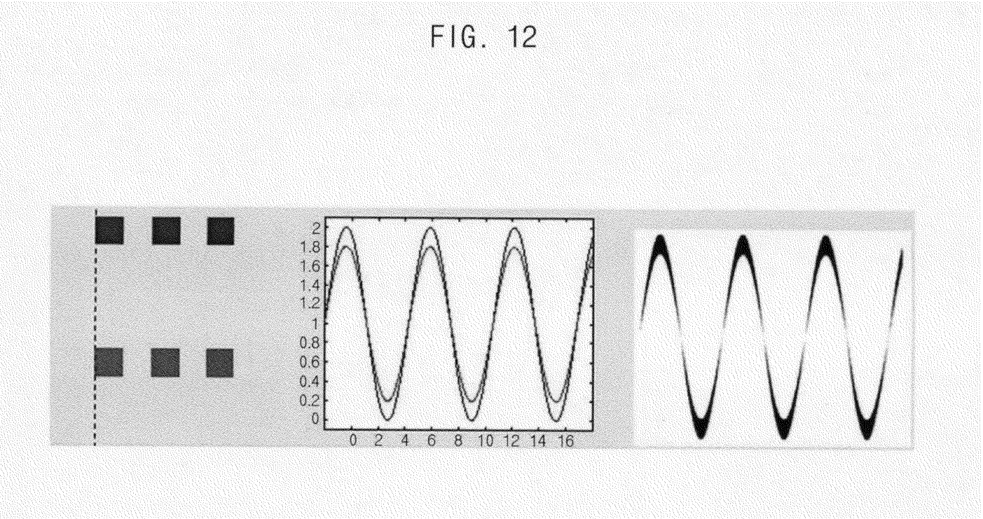

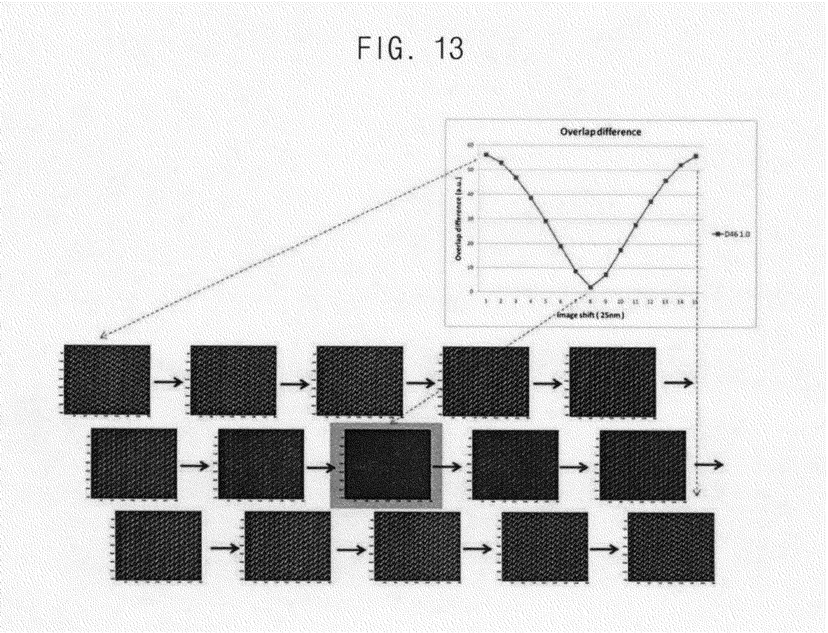

In step ST210, as shown in FIGS. 9 and 10, the shifting member 126 may shift the second actual image on the reference image in a horizontal axis and/or a vertical axis to a position at which the area difference may be minimized. The shifted second actual image may have a pitch substantially the same as that of the reference image. Therefore, the reference point of the second actual image may be aligned with the reference point of the reference image.

The position where the overlap difference between the two images may be identified by the shift process.

In step ST212, the image-correcting member 128 may correct the second actual image to provide the second actual image with a size substantially the same as that of the reference image. In some example embodiments, the correcting process of the second actual image may be performed simultaneously with the shifting process of the second actual image.

In step ST214, the calculating unit 130 may convert the relative position difference values into the absolute position difference value with respect to the reference point of the mask M. In some example embodiments, the reference point of the mask M may include a center point of the mask M. When only the second actual image may be compared with the reference image, the absolute position difference value may correspond to a registration of the mask M.

In contrast, when a plurality of the actual images may be compared with the reference image, a plurality of absolute position difference values by a same point on each of the actual images may be obtained. The calculating unit 130 may calculate an average value of the absolute position difference values by the point. The average value may correspond to a registration of the mask M. The average value may more accurately represent the registration of the mask M.

According to some example embodiments, the actual images obtained from the actual mask patterns may be compared with the reference image obtained from any one of the actual mask patterns to calculate the registration of the mask. Thus, because the registration may be obtained from the actual mask patterns, it may not be required to form an additional alignment key on the object. Further, because the measured registration may be obtained from the actual images, the measured registration may accurately represent a registration of the actual mask pattern. As a result, the mask pattern corrected using the registration may have a desired shape accurately located at a desired position, so that a pattern formed using the mask including the corrected mask pattern may have a desired shape positioned at a desired position.

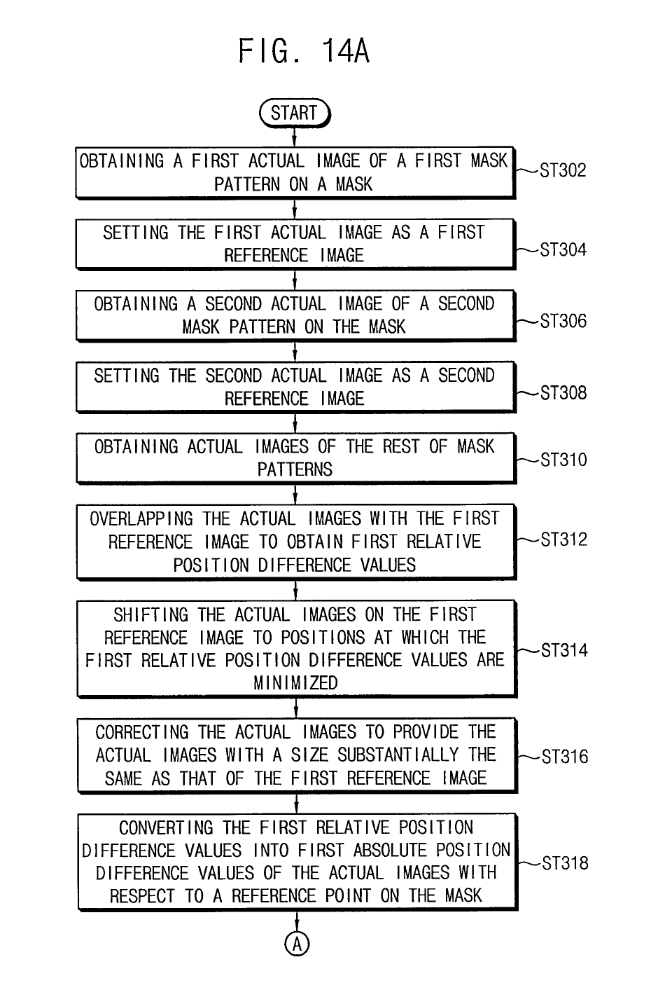

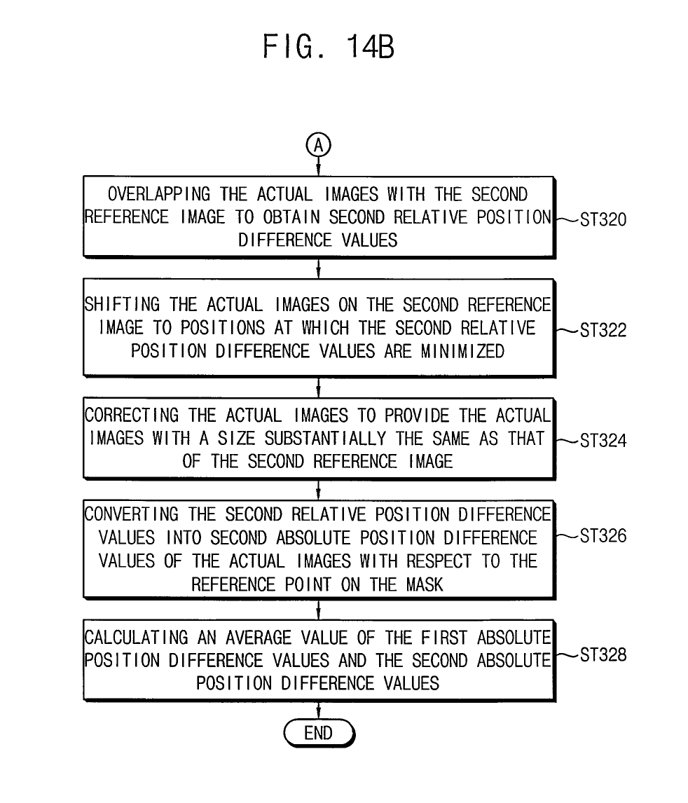

FIGS. 11A and 11B are flow charts illustrating a method of measuring a registration of a mask using the apparatus in FIG. 1 in accordance with some example embodiments.

Referring to FIGS. 1, 11A, and 11B, in step ST302, the image-obtaining unit 110 may photograph the first mask pattern in the first region of the mask M to obtain the first actual image.

In step ST304, the image-comparing unit 120 may set the first actual image as a first reference image.

In step ST306, the image-obtaining unit 110 may photograph the second mask pattern in the second region of the mask M to obtain a second actual image.

In step ST308, the image-comparing unit 120 may set the second actual image as a second reference image.

In some example embodiments, the second region may be substantially the same as or different from the second region illustrated with reference to FIG. 2. That is, the second actual image as the second reference image may be obtained from any one of the rest of the regions except for the first region. In order to accurately measure a registration, the second actual image may be obtained from the second mask pattern in the second region that may be arranged symmetrically with the first region with respect to the center point of the mask M.

In step ST310, the image-obtaining unit 110 may photograph the mask patterns in other regions of the mask M except for the first region and the second region to obtain the actual images.

In step ST312, the image-overlapping member 122 of the image-comparing unit 120 may overlap the actual images with the first reference image to obtain first relative position difference values of the actual images with respect to the first reference image.

In step ST314, the shifting member 126 may shift the actual images on the first reference image in a horizontal axis and/or a vertical axis to positions at which the first position difference values may be minimized.

In step ST316, the image-correcting member 128 may correct the actual images to provide the actual images with a size substantially the same as that of the first reference image.

In step ST318, the calculating unit 130 may convert the first relative position difference values into the first absolute position difference values with respect to the reference point of the mask M. The calculating unit 130 may calculate a first average value of the first absolute position difference values by the point.

In step ST320, the image-overlapping member 122 of the image-comparing unit 120 may overlap the actual images with the second reference image to obtain second relative position difference values of the actual images with respect to the second reference image.

In step ST322, the shifting member 126 may shift the actual images on the second reference image in a horizontal axis and/or a vertical axis to positions at which the second position difference values may be minimized.

In step ST324, the image-correcting member 128 may correct the actual images to provide the actual images with a size substantially the same as that of the second reference image.

In step ST326, the calculating unit 130 may convert the second relative position difference values into the second absolute position difference values with respect to the reference point of the mask M. The calculating unit 130 may calculate a second average value of the second absolute position difference values by the point.

In step ST328, the calculating unit 130 may calculate a final average value of the first average value and the second average value to obtain a registration of the mask M.

In some example embodiments, the registration of the mask may be measured by setting the two actual images, which may be obtained from the two mask patterns in the two regions, as the two reference images. Alternatively, at least three actual images may be set as reference images. That is, because the image-obtaining unit 110 may photograph the mask patterns in the entire regions of the mask to obtain the actual images, the method of some example embodiments may be performed by setting at least three or all of the actual images as the reference images.

According to some example embodiments, the registration of the mask may be measured by comparing the actual images with at least two reference images obtained from the actual mask patterns. Thus, the method of some example embodiments may more accurately measure the registration compared with the method of measuring the registration of the mask using only one reference image.

The method and/or apparatus of some example embodiments may be applied to measuring the registration of the mask. Alternatively, the method and the apparatus of some example embodiments may be used for aligning the object having patterns. For example, the method and/or apparatus of some example embodiments may be applied to an exposing method and exposing apparatus. Particularly, the measured registration may represent misalignments of the patterns in the object, so that the mask in the exposing apparatus may be aligned using the measured registration without an additional registration key.

According to some example embodiments, after the actual image among any one of the patterns on the object may be set as the reference image, the actual images of the rest of the patterns may be compared with the reference image to obtain the relative position difference values. The relative position difference values may be converted into the absolute position difference values with respect to the reference point on the object. The object may be aligned based on the absolute position difference values. The absolute position difference values may be obtained from the actual image of the actual patterns. Thus, it may not be required to form an additional alignment key on the object.

Further, because the measured absolute position difference values may correspond to values obtained from the actual images, the absolute position difference values may accurately represent misalignments of the actual patterns. Particularly, when the object may include the mask, the absolute position difference values may correspond to the registration of the mask. Thus, when the mask pattern may be corrected based on the registration, the corrected mask pattern may have a desired shape accurately located at a desired position. As a result, a pattern formed using the mask including the corrected mask pattern may have a desired shape positioned at a desired position.

While example embodiments have been particularly shown and described, it will be understood by those of ordinary skill in the art that various changes in form and details may be made therein without departing from the spirit and scope of the present invention as defined by the following claims.

1. A method of aligning an object, the method comprising:
obtaining a first actual image of a first pattern on the object;
setting the first actual image as a first reference image;
obtaining a second actual image of a second pattern on the object;
comparing the second actual image with the first reference image to obtain first relative position difference values of the second actual image with respect to the first reference image; and
converting the first relative position difference values into first absolute position difference values with respect to a reference point on the object.

2. The method of claim 1, wherein the comparing the second actual image with the first reference image comprises overlapping the second actual image with the first reference image.

3. The method of claim 2, wherein the comparing the second actual image with the first reference image further comprises obtaining contrast waveforms of the first reference image and the second actual image.

4. The method of claim 3, wherein the obtaining contrast waveforms comprises:
setting an allowable range on the contrast waveforms; and
removing portions of the contrast waveforms beyond the allowable range from the contrast waveforms.

5. The method of claim 2, wherein the comparing the second actual image with the first reference image further comprises shifting the second actual image on the first reference image to a position at which the first relative position difference values are minimized.

6. The method of claim 5, wherein the comparing the second actual image with the first reference image further comprises correcting the second actual image to provide the second actual image with a size substantially the same as that of the first reference image.

7. The method of claim 1, further comprising:
obtaining a third actual image of a third pattern on the object;
setting the third actual image as a second reference image;
obtaining a fourth actual image of a fourth pattern on the object;
comparing the fourth actual image with the second reference image to obtain second relative position difference values of the fourth actual image with respect to the second reference image; and
converting the second relative position difference values into second absolute position difference values with respect to the reference point on the object.

8. The method of claim 7, further comprising:
calculating an average value of the first absolute position difference values and the second absolute position difference values.

9. The method of claim 1, wherein the reference point comprises a center point of the object.

10. The method of claim 1, wherein the object comprises a mask,
wherein the patterns comprise mask patterns on the mask, and
wherein the first absolute position difference values comprise a registration of the mask.

11. An apparatus for aligning an object, the apparatus comprising:
an image-obtaining unit configured to obtain actual images of patterns on the object;
an image-comparing unit configured to set at least one of the actual images as a reference image, and configured to compare the actual images with the reference image to obtain relative position difference values of the actual images with respect to the reference image; and
a calculating unit configured to convert the relative position difference values into absolute position difference values with respect to a reference point on the object.

12. The apparatus of claim 11, wherein the image-comparing unit comprises:
an image-overlapping member configured to overlap the actual images with the reference image; and
a shifting member configured to shift the actual images on the reference image to positions at which the relative position difference values are minimized.

13. The apparatus of claim 12, wherein the image-overlapping member comprises:
a contrast obtainer configured to obtain contrast waveforms of the reference image and the actual images; and
a filter configured to remove portions of the contrast waveforms beyond an allowable range from the contrast waveforms.

14. The apparatus of claim 12, wherein the image-comparing unit further comprises an image-correcting member configured to correct the actual images to provide the actual images with a size substantially the same as that of the reference image.

15. The apparatus of claim 11, wherein the object comprises a mask,
wherein the patterns comprise mask patterns on the mask, and
wherein the absolute position difference values comprise a registration of the mask.

16. A method of aligning an object, the method comprising:
setting an actual image of a first pattern on the object as a first reference image;
determining first relative position difference values based on an actual image of a second pattern on the object and the first reference image; and
converting the first relative position difference values into first absolute position difference values with respect to a reference point on the object.

17. The method of claim 16, wherein the object comprises a mask, the patterns comprise mask patterns on the mask, and the absolute position difference values comprise a registration of the mask.

18. The method of claim 16, wherein the reference point comprises a center point of the object.

19. The method of claim 16, further comprising:
setting an actual image of a third pattern on the object as a second reference image;
comparing an actual image of a fourth pattern on the object with the second reference image to obtain second relative position difference values; and
converting the second relative position difference values into second absolute position difference values with respect to the reference point on the object.

20. The method of claim 19, further comprising:
calculating an average value of the first and second absolute position difference values.
